(19) United States
(12) Patent Application Publication
(10) Pub. No.: US 2005/0151021 A1
(43) Pub. Date: Jul. 14, 2005

(54) Heat dissipating, light-reflecting plates for radiator systems of spacecraft and methods for fabricating the same

(76) Inventors: Douglas C. Hamilton, Redondo Beach, CA (US); Patrick J. Alsup, Torrance, CA (US); Theresa J. Alsup, Torrance, CA (US)

Correspondence Address: INGRASSIA FISHER & LORENZ, P.C., 7150 E. CAMELBACK, STE. 325, SCOTTSDALE, AZ, 85251, US

(21) Appl. No.: 10/740,294

(22) Filed: Dec. 17, 2003

(51) Int. Cl. B64G 1/46

(52) U.S. Cl. 244/163

(57) ABSTRACT

A heat-dissipating, light-reflecting plate for a radiator of a spacecraft is provided. The heat-dissipating, light-reflecting plate has an at least partially transparent, thermally conductive layer and a plurality of first light-reflecting surfaces disposed proximate to the at least partially transparent, thermally conductive layer. A plurality of second light-reflecting surfaces also is disposed proximate to the at least partially transparent, thermally conductive layer. At least a first sub-set of the plurality of second light-reflecting surfaces is oriented at a first angle to at least a first sub-set of the plurality of first light-reflecting surfaces.

### FIELD OF THE INVENTION

The present invention generally relates to radiative systems for spacecraft, and more particularly relates to heat-dissipating, light-reflecting radiator systems for spacecraft and methods of making heat-dissipating, light-reflecting radiator systems for spacecraft.

### BACKGROUND OF THE INVENTION

The thermal control of spacecraft, such as Earth-orbiting satellites, space stations, and space modules, has been a long standing challenge. In a typical Earth-orbiting satellite 1, shown in FIG. 1, power is generated by solar arrays, which comprise a number of strings of solar cells attached to solar panel structures 2, 3. As illustrated in FIG. 1, the body of the satellite rotates about an axis of the solar panel structures 2, 3, which do not rotate. The power generated by the solar arrays may be used by bus and payload units of the spacecraft or stored in batteries. The use of the power by the bus and payload of the spacecraft, whether for generation of radio-frequency signals transmitted by dishes 4, 5 or any other desired function, results in power dissipation, which typically generates a significant amount of heat. The significant heat buildup typically is liberated by the spacecraft using radiator systems 6, 7 disposed on sides of the spacecraft.

Earth-orbiting spacecraft not only generate heat but also receive direct radiation from the sun. Accordingly, one type of radiator system for spacecraft is designed to reflect light from the sun to reduce any additional heat buildup in the spacecraft. Typically, such radiator systems utilize a second surface mirror having a flat reflective surface. While this type of radiator system may reflect light from the sun, it reflects the solar light in a direction dependant on the angle at which the incident light beams hit the reflective material. Accordingly, as illustrated in FIG. 2, light reflected from the radiator systems 6, 7 can be reflected onto the solar cells of solar panels 2, 3, particularly the solar cells closest to radiator systems 6, 7, causing over-illumination and over-heating of these solar cells and other solar array components. This over-illumination area is depicted as over-illumination region 9 in FIG. 2.

Over-illumination of the solar cells can result in a variety of deleterious effects. Elevated operating temperatures of the solar cells can reduce cell efficiency and power output of the solar cell arrays. In addition, abrupt changes and highly localized variations in illumination from one solar cell in a solar cell string to another can contribute to an increase in electrostatic discharge events, such as sparking and arcing, often leading to solar cell circuit failure. Moreover, over-illumination of the solar cells and other solar array components may induce heating that causes higher outgassing rates and degradation of the polymer materials and adhesives used to form the solar panels. Higher outgassing rates result in more rapid deposition of polymer films on the solar cells, thus reducing power generation. Degradation of the polymer materials of the solar panels may cause loss of mechanical stability of the panels and can lead to solar cell cracking, micro-cracking, and electrical component open, short and soft-short conditions.

Accordingly, it is desirable to provide a heat-dissipating, light-reflecting plate for a radiator of a spacecraft wherein the light-reflecting plate minimizes or eliminates the amount of solar radiation reflected from the radiator to the solar panels. In addition, it is desirable to provide a radiator that is configured to minimize or eliminate the amount of solar radiation reflected from the radiator to the solar panels for normal spacecraft operation orientations with respect to the sun. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

In accordance with an exemplary embodiment of the present invention, a heat-dissipating, light-reflecting plate for a radiator of a spacecraft is provided. The heat-dissipating, light-reflecting plate comprises an at least partially transparent, thermally conductive layer and a plurality of first light-reflecting surfaces disposed proximate to the at least partially transparent, thermally conductive layer. The light-reflecting plate further comprises a plurality of second light-reflecting surfaces disposed proximate to the at least partially transparent, thermally conductive layer. At least a first sub-set of the plurality of second light-reflecting surfaces is oriented at a first angle to at least a first sub-set of the plurality of first light-reflecting surfaces.

In accordance with another exemplary embodiment of the present invention, a radiator system of a spacecraft is provided. The radiator system comprises a heat-transport apparatus and a heat-dissipating, light-reflecting plate disposed proximate to the heat-transport apparatus and configured to receive heat from the heat-transport apparatus. The heat-dissipating, light-reflecting plate comprises an at least partially transparent, thermally conductive layer and a plurality of first light-reflecting surfaces disposed proximate to the at least partially transparent, thermally conductive layer. The heat-dissipating, light-reflecting plate further comprises a plurality of second light-reflecting surfaces disposed proximate to the at least partially transparent, thermally conductive layer. At least a first sub-set of the plurality of second light-reflecting surfaces is oriented at a first angle to at least a first sub-set of the plurality of first light-reflecting surfaces.

In accordance with a further exemplary embodiment of the present invention, a spacecraft radiator system is provided. The spacecraft radiator system comprises a heat-generating portion of a spacecraft and a heat-transport apparatus connected to the heat-generating portion of a spacecraft and configured to remove heat from the heat-generating portion of the spacecraft. The spacecraft radiator system further comprises a heat-dissipating, light-reflecting plate disposed proximate to the heat-transport apparatus. The heat-dissipating, light-reflecting plate comprises an at least partially transparent, thermally conductive layer and a plurality of first light-reflecting surfaces disposed proximate to the at least partially transparent, thermally conductive layer. The heat-dissipating, light-reflecting plate further comprises a plurality of second light-reflecting surfaces disposed proximate to the at least partially transparent, thermally conductive layer. At least a first sub-set of the plurality of second light-reflecting surfaces is oriented at a first angle to at least a first sub-set of the plurality of first light-reflecting surfaces.

In accordance with yet another exemplary embodiment of the present invention, a method of fabricating a heat-dissipating, light-reflecting plate for a radiator of a spacecraft is provided. The method comprises providing a machine tool having a patterned surface with a plurality of first inclined surfaces thereon and a plurality of second inclined surfaces thereon. At least a first sub-set of the plurality of second inclined surfaces is oriented at a first angle to at least a first sub-set of the plurality of first inclined surfaces. The method further comprises depositing a first space-qualified, thermally conductive material overlying the surface of the machine tool so that the first space-qualified, thermally conductive material forms a layer having a patterned surface that is a reverse image of the patterned surface of the machine tool. The first space-qualified, thermally conductive material layer is removed from the machine tool and a light-reflecting layer is formed overlying the patterned surface of the first space-qualified, thermally conductive material layer. The light-reflective layer then is coupled to a radiator of a spacecraft.

### BRIEF DESCRIPTION OF THE DRAWINGS

The present invention will hereinafter be described in conjunction with the following drawing figures, wherein like numerals denote like elements, and

FIG. 1 shows a typical Earth-orbiting satellite having solar panels and heat radiating surfaces;

FIG. 2 illustrates the reflection of solar radiation from a radiator of a spacecraft onto the solar panels of the spacecraft;

FIG. 3 is a cross-sectional view of a heat-dissipating, light-reflecting plate for a radiator of a spacecraft in accordance with one exemplary embodiment of the present invention;

FIG. 4 is a cross-sectional view of a heat-dissipating, light-reflecting plate for a radiator of a spacecraft in accordance with another exemplary embodiment of the present invention;

FIG. 5 is a cross-sectional view of a heat-dissipating, light-reflecting plate for a radiator of a spacecraft in accordance with a further exemplary embodiment of the present invention;

FIG. 6 is a schematic representation of a light-reflecting layer of a heat-dissipating, light-reflecting plate for a radiator of a spacecraft in accordance with one embodiment of the present invention;

FIG. 7 illustrates a ray trace of a light ray striking the light-reflecting layer of FIG. 6;

FIG. 8 is a cross-sectional view of the ray trace of FIG. 7;

FIG. 9 is a side view of the ray trace of FIG. 7;

FIG. 10 is a schematic representation of a light-reflecting layer of a heat-dissipating, light-reflecting plate for a radiator of a spacecraft in accordance with another embodiment of the present invention;

FIGS. 11-13 illustrate ray traces of various light rays striking the light-reflecting layer of FIG. 10;

FIG. 14 is a flowchart of a method for fabricating a heat-dissipating, light-reflecting plate in accordance with an exemplary embodiment of the present invention; and

FIG. 15 is a cross-sectional view of a spacecraft radiator system in accordance with an embodiment of the present invention.

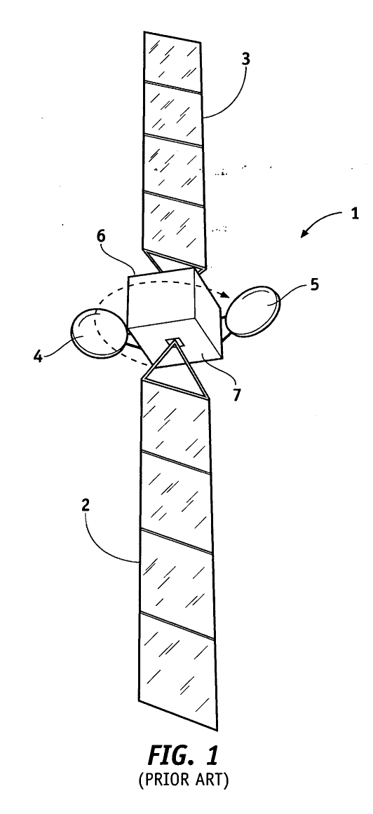

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

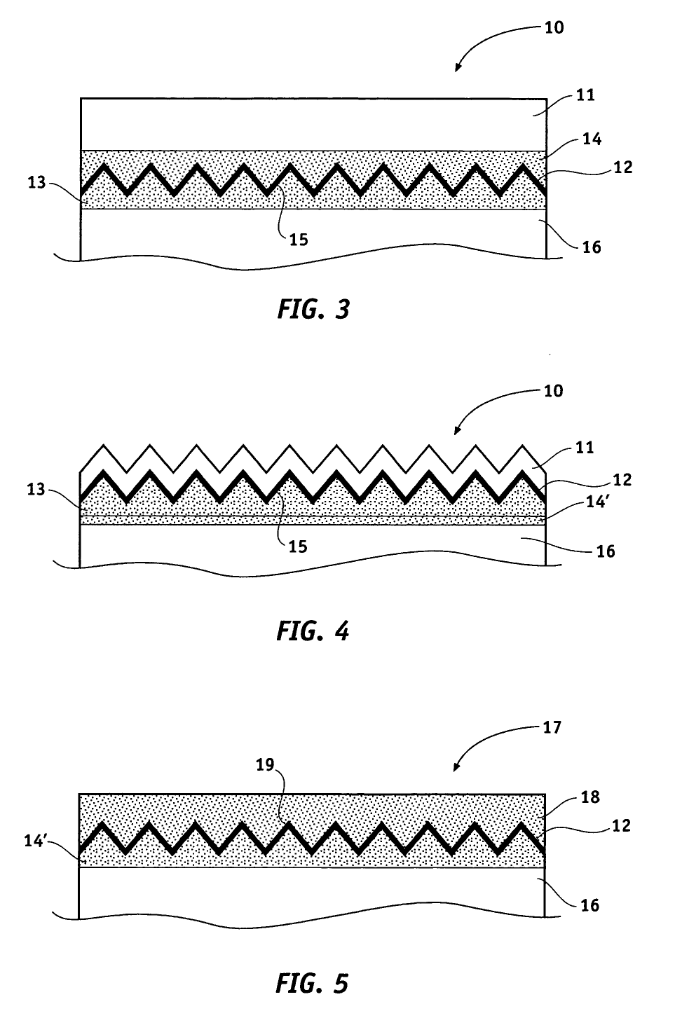

The present invention comprises a heat-dissipating, light-reflecting plate for a radiator of a spacecraft wherein the heat-dissipating, light-reflecting plate reduces, minimizes or eliminates the amount of solar radiation reflected from the radiator to the solar panels of the spacecraft. FIG. 3 illustrates an exemplary embodiment of a heat-dissipating, light-reflecting radiator plate 10 for use with a radiator 16 of a spacecraft in accordance with the present invention. Radiator plate 10 comprises a thermally conductive layer 11. Thermally conductive layer 11 may be formed of any space-qualified material(s) that is suitably absorptive, conductive and radiative in the infrared region of the electromagnetic spectrum and that is at least partially transparent in the visible region of the electromagnetic spectrum and in the region of the electromagnetic spectrum comprising “long” ultraviolet wavelengths, that is, wavelengths in the range of about 250 nm to about 400 nm. An example of a suitable material from which to fabricate thermally conductive layer 11 is silica, preferably fused silica. Preferably, thermally conductive layer 11 has a substantially uniform thickness. In one exemplary embodiment of the invention, thermally conductive layer 11 has a substantially uniform thickness in the range of about 0.001 inches to about 0.01 inches thick. In a preferred embodiment of the present invention, thermally conductive layer 11 has a substantially uniform thickness in the range of about 0.003 inches to about 0.008 inches. In a more preferred embodiment of the present invention, thermally conductive layer 11 has a substantially uniform thickness in the range of about 0.005 to 0.006 inches.

Radiator plate 10 further comprises a thermally conductive light-reflecting layer 12 having a patterned surface. As used herein, the term “patterned surface” means any non-flat surface. Light-reflecting layer 12 may be formed of any reflective material that suitably reflects at least a portion of the incident solar light that is transmitted from the sun through thermally conductive layer 11. Examples of materials that may be used to form light-reflecting layer 12 include reflective metals, such as aluminum, silver, nickel, and the like. In one embodiment of the invention, light-reflecting layer 12 has a thickness in the range of about 500 to 5000 angstroms. In a preferred embodiment of the invention, light-reflecting layer 12 has a thickness in the range of about 1000 to 3000 angstroms. In a more preferred embodiment of the invention, light reflecting layer 12 has a thickness of about 2000 angstroms.

In one exemplary embodiment of the invention, light-reflecting layer 12 may be affixed to thermally conductive layer 11 using any suitable method. In one embodiment of the invention, light-reflecting layer 12 may be affixed to thermally conductive layer 11 using any suitable thermally conductive adhesive 14, such as, for example, a silicone adhesive, that is at least partially transparent in the visible and long ultraviolet regions of the electromagnetic spectrum.

In a further exemplary embodiment of the invention, as illustrated in FIG. 4, a relatively thin film of thermally conductive layer 11 may be deposited on or otherwise disposed overlying light reflecting layer 12. In this manner, at least one surface of thermally conductive layer 11, such as an exposed surface, is conformal to the patterned surface of light reflecting layer 12. In an alternative embodiment of the invention, a film of thermally conductive layer 11 having a sufficient thickness may be deposited on or otherwise disposed overlying light reflecting layer 12 such that a surface of thermally conducting layer 11, such as an exposed surface, is substantially flat.

Referring again to FIG. 3, and to FIG. 4, radiator plate 10 also may comprise a thermally conductive substrate 13. In one exemplary embodiment of the invention, light-reflecting layer 12 and substrate 13 may be formed of the same material. In another exemplary embodiment of the invention, light-reflecting layer 12 and substrate 13 may be formed of the same material and be integrally formed. In yet another exemplary embodiment of the present invention, substrate 13 may comprise any suitable space-qualified material having a patterned surface 15 upon which light-reflecting layer 12 may be disposed. In one exemplary embodiment of the invention, substrate 13 may comprise a metal. In another, preferred, exemplary embodiment of the invention, substrate 13 may comprise any polymer material that is suitable for space applications, such as, for example, space-qualified polyimide.

Radiator plate 10 may be coupled to a surface of radiator 16 by any suitable method that permits heat transport between radiator 16 and radiator plate 10. In an exemplary embodiment of the invention, substrate 13 of radiator plate 10 is coupled to a surface of a radiator 16 by a suitable thermally conductive adhesive 14′, which may or may not be at least partially transparent. In another exemplary embodiment of the invention, radiator plate 10 may be coupled to a surface of radiator 16 using a suitable mechanical fastening method, such as, for example, clamps, screws, brackets, and the like.

FIG. 5 illustrates a heat-dissipating, light reflecting radiator plate 17 in accordance with another exemplary embodiment of the present invention. Radiator plate 17 comprises an at least partially transparent, thermally conductive layer 18. Thermally conductive layer 18 may be formed of any material or materials that may be used to form thermally conductive layer 11, as described above with reference to FIG. 3. Thermally conductive layer 18 has a patterned surface 19 upon which light-reflecting layer 12 may be deposited so that light reflecting layer 12 is formed with a patterned surface that is conformal to patterned surface 19. Radiator plate 17 may be coupled to a surface of radiator 16 by any suitable method that permits heat transport between the radiator 16 and radiator plate 17. In an exemplary embodiment of the invention, light-reflecting layer 12 of radiator plate 17 is coupled to a surface of radiator 16 by a suitable thermally conductive adhesive 14′, which may or may not be at least partially transparent. In another exemplary embodiment of the invention, radiator plate 17 may be coupled to a surface of radiator 16 using a suitable mechanical fastening method, such as, for example, clamps, screws, brackets, and the like.

Referring to FIGS. 3-6, in accordance with one exemplary embodiment of the present invention, light-reflecting layer 12 may comprise a light-reflecting layer 20. Light-reflecting layer 20 may comprise a plurality of first light-reflecting surfaces, S_{X}, where X is a number between 1 and N and where N represents a total number of at least a subset of the first light-reflecting surfaces. Light-reflecting layer 20 also may comprise a plurality of second light-reflecting surfaces, L_{X}. Second light-reflecting surfaces L₁ to L_{N} are disposed intermittently between the first light-reflecting surfaces, with each first light-reflecting surface S_{X} corresponding to second light-reflecting surface L_{X}. Each first light-reflecting surface S_{X} is disposed at an angle α_{X} from an axis normal to a surface of radiator 16 and from the x-y plane, which is parallel to the plane of a surface of the radiator. Each second light-reflecting surface L_{X} is disposed at an angle β_{X} from the axis normal to the surface of radiator 16 and from the x-y plane. Accordingly, each second light-reflecting surface L_{X} is disposed at an angle (α_{X}+β_{X}) to the corresponding first light-reflecting surface S_{X}, thus forming a plurality of parallel channels or grooves. In one exemplary embodiment of the present invention, the channels may have a width 21 in the range of about 0.001 inches to about 0.005 inches and a depth 22 in the range of about 0.001 inches to about 0.005 inches. In a preferred embodiment of the present invention, the channels have a width 21 and a depth 22 in the range of about 0.001 to about 0.002 inches.

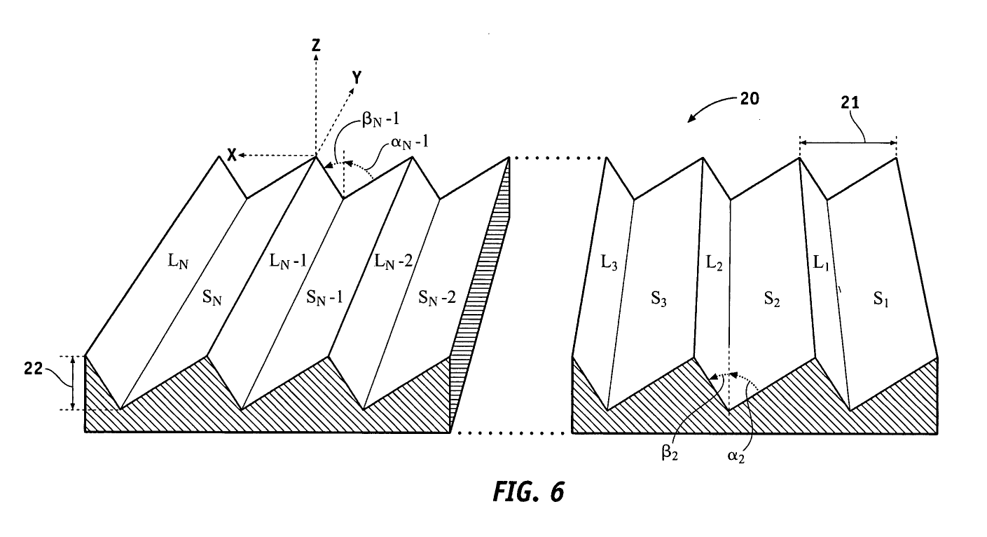

While FIG. 6 illustrates the channels of light-reflecting layer 20 adjacent to each other, it will be understood that the invention is not so limited. Any number of suitably configured surfaces and/or structures may be disposed between the channels. For example, in one exemplary embodiment of the invention, one or more channels may be separated from other channels by an array of inverted tetrahedral-shaped structures. Alternatively, in another embodiment of the invention, the one or more channels may be separated from other channels by substantially flat surfaces.

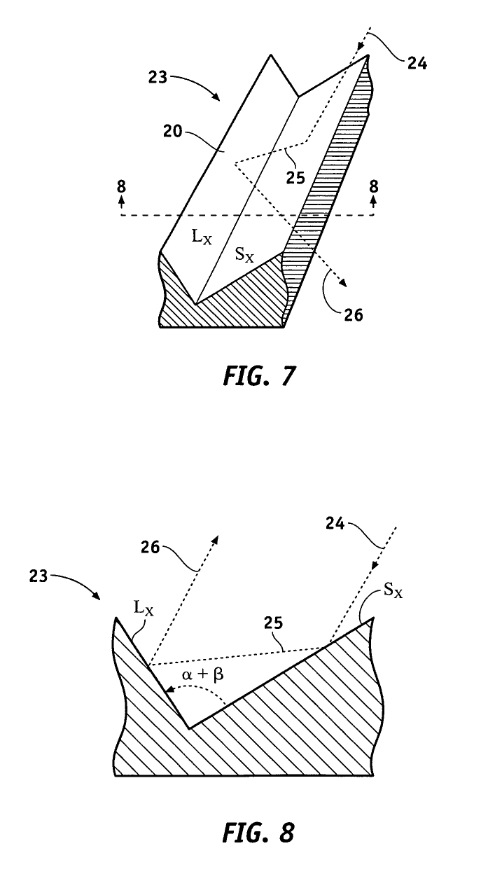

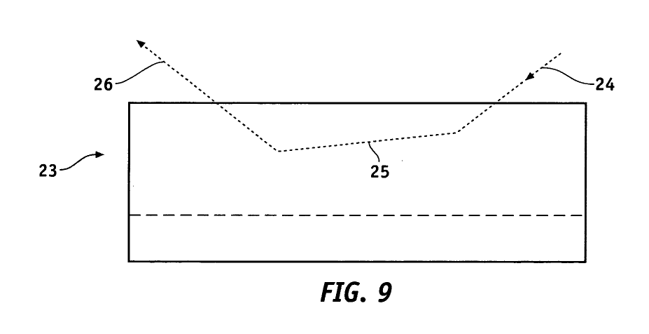

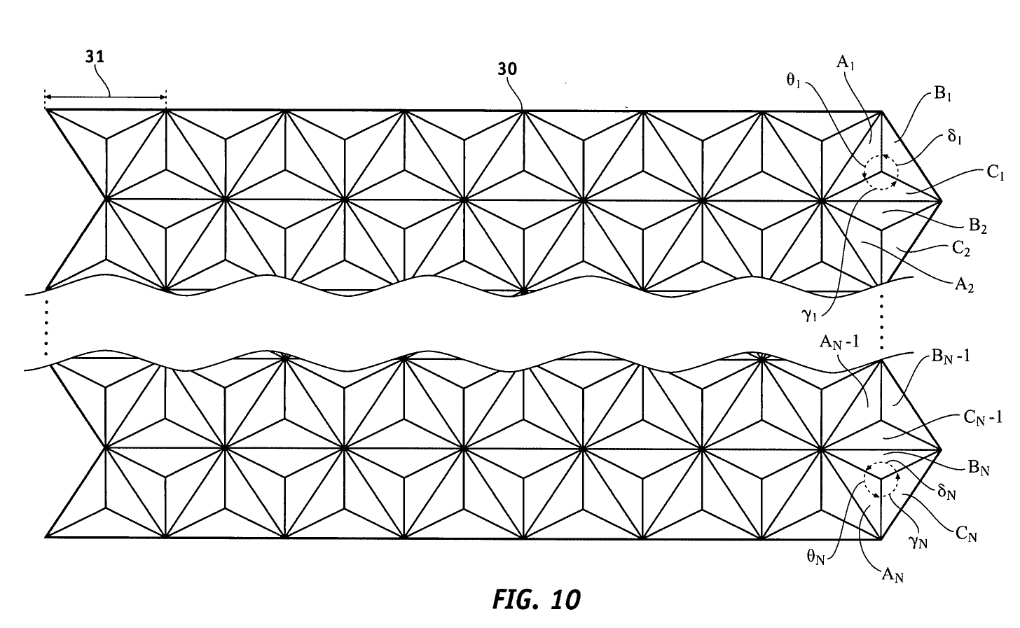

FIGS. 7-9 are various views of one exemplary ray trace 23 for a channel of light-reflecting layer 20 when the angle (α_{X}+β_{X}) is 90° (ninety degrees). When a light ray 24 approaches first light-reflecting surface S_{X}, it is reflected off of first light-reflecting surface S_{X} as light ray 25 and strikes second light-reflecting surface L_{X}. Light ray 25 is reflected off of second light-reflecting surface L_{X} as light ray 26. It will be appreciated that when the angle (α_{X}+β_{X}) is 90°, the plane including light ray 24 and parallel to the axis of the channel is parallel to the plane including light ray 26 and parallel to the axis of the channel. Accordingly, by manipulating the size of the angles α_{X} and β_{X}, and by manipulating the orientation of the first light-reflecting surfaces S_{X} and second light-reflecting surfaces L_{X} relative to the surface of the radiator, the amount of light reflected onto the solar panels from light-reflecting layer 20 may be reduced, minimized or eliminated throughout the spacecraft's orbit for all normal spacecraft operation orientations with respect to the sun.

The various angles α_{X} and β_{X} of light-reflecting layer 20 may be altered or “fine-tuned” to take into account the change of orientation of the light-reflecting layer 20 relative to the sun and the solar panels as the spacecraft rotates about its axis and orbits about the earth. For example, when the spacecraft is a satellite, such as a telecommunications satellite, the spacecraft typically rotates about the axis of the solar panels. The spacecraft is rotated about this axis so that the solar panels continuously face the sun and the spacecraft maintains a desired orientation to the earth. Thus, as the spacecraft travels and rotates, the orientation of the light-reflecting layer 20 relative to the sun and the solar panels changes. By manipulating the various angles α_{X} and β_{X}, the amount of light reflected onto the solar panels from light-reflecting layer 20 may be reduced, minimized or eliminated throughout the spacecraft's orbit. Accordingly, in one embodiment of the present invention, the angles α₁ through α_{N} are equal. In another embodiment of the present invention, two or more angles α_{X} may differ from each other. Similarly, in one embodiment of the present invention, the angles β₁ through β_{N} are equal. In another embodiment of the present invention, two or more angles β_{X} may differ from each other.

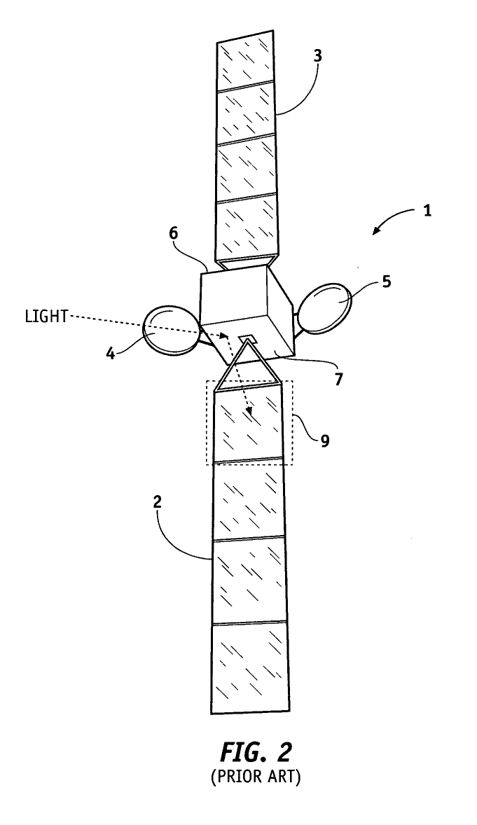

Referring to FIGS. 2 and 6, in another exemplary embodiment, when angles α₁ through α_{N} are each approximately 78.25° and angles β₁ through β_{N} are each approximately 11.75° and the channels of light-reflecting layer 20 are aligned parallel to a line from dishes 4 and 5, then approximately no light is reflected towards the solar arrays for the zero degree spacecraft body position shown in FIG. 2. The light reflected towards the solar arrays is minimized for the spacecraft body rotation angles near about 90° and light is not reflected towards the solar arrays for all spacecraft body rotation angles in excess of 95°.

Referring to FIG. 10, in accordance with another exemplary embodiment of the present invention, light-reflecting layer 12 may have the patterned surface of a light-reflecting layer 30. Light-reflecting layer 30 may comprise a plurality of first light-reflecting surfaces, A_{X}, where X is a number between 1 and N and where N represents a total number of at least a subset of the first light-reflecting surfaces. Light-reflecting layer 30 also may comprise a plurality of corresponding second light-reflecting surfaces, B_{X}. Each second light-reflecting surfaces B_{X} is disposed at an angle γ_{X} to a corresponding first light-reflecting surface A_{X}. Light-reflecting layer 30 also may comprise a plurality of corresponding third light-reflecting surfaces, C_{X}. Each third light-reflecting surface C_{X} is disposed at an angle δ_{X} to a corresponding first light-reflecting surface A_{X} and is disposed at an angle θ_{X} to a corresponding second light-reflecting surface B_{X}. Accordingly, first light-reflecting surface A_{X}, second light-reflecting surface B_{X} and third light-reflecting surface C_{X} may form an inverted tetrahedral-shaped cell. If surfaces A_{X}, B_{X} and C_{X} are each mutually orthogonal, the surfaces may form a corner cube-oriented cell. In one exemplary embodiment of the present invention, the inverted tetrahedral-shaped cells may have a width 31 in the range of about 0.001 inches to about 0.010 inches and a depth (not shown) in the range of about 0.001 inches to about 0.005 inches. In a preferred embodiment of the present invention, the inverted tetrahedral-shaped cells have a width 31 and a depth in the range of about 0.001 to about 0.002 inches.

By manipulating one or more angles γ_{X}, δ_{X}, and θ_{X}, the reflectance of light-reflecting layer 30 may be optimized to reduce, minimize or eliminate the amount of light reflected onto the solar panels of a spacecraft. Accordingly, in one exemplary embodiment of the present invention, the angles γ₁ through angle γ_{N} are equal, the angles δ₁ through angle δ_{N} are equal and the angles θ₁ through angle θ_{N} are equal. In another exemplary embodiment of the present invention, the angles γ₁ through angle γ_{N}, the angles δ₁ through angle δ_{N}, and the angles θ₁ through angle θ_{N} are all equal. In a further exemplary embodiment of the present invention, two or more angles γ_{X} may differ from each other. Similarly, in yet another exemplary embodiment of the present invention, two or more angles δ^{X} may differ from each other. Likewise, in yet another exemplary embodiment of the present invention, two or more angles θ_{X} may differ from each other. Thus, in any one embodiment of the present invention, any number of angles γ₁ through angle γ_{N} may be the same or different, any number of angles δ₁ through angle δ_{N} may be the same or different, and any number of angles θ₁ through angle θ_{N} may be the same or different.

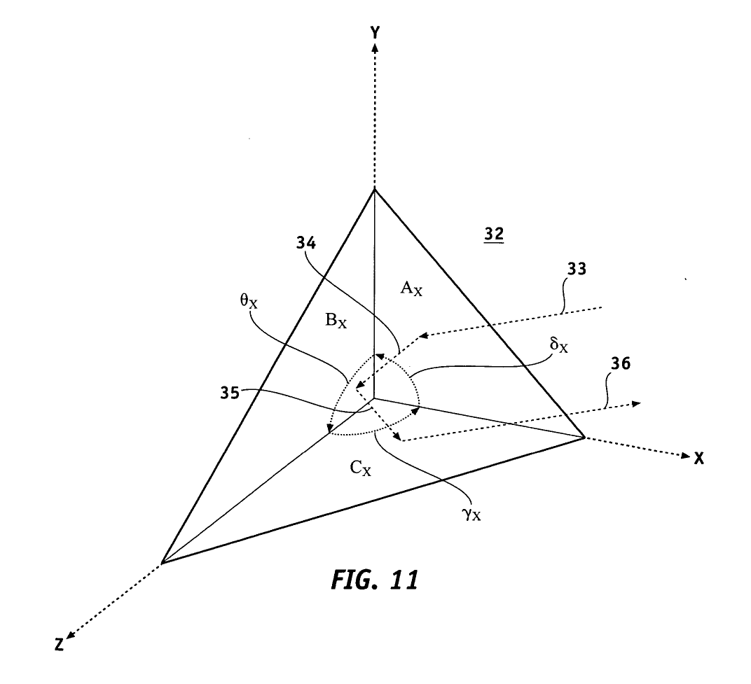

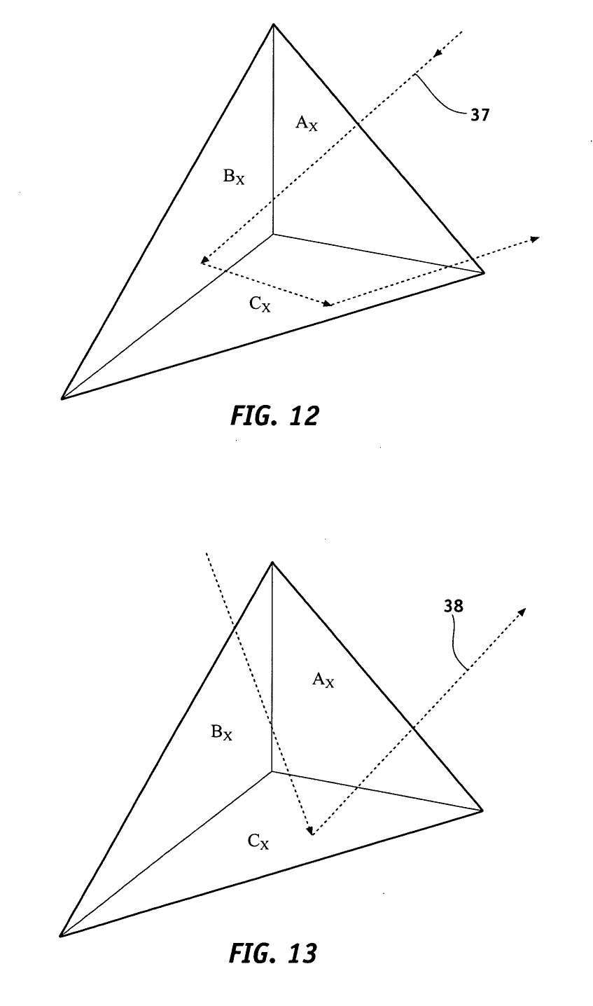

Further, light-reflecting layer 30 may be configured to take into account the change of orientation of light-reflecting layer 30 relative to the sun and the solar panels as the spacecraft rotates about its axis and orbits about the earth. FIG. 11 is an illustration of an exemplary ray trace 32 for light-reflecting layer 30. A light ray 33 approaches and strikes first light-reflecting surface A_{X}. Light ray 33 is reflected off of first light-reflecting surface Ax as light ray 34, which strikes second light-reflecting surface B_{X}. Light ray 34 then is reflected off second light-reflecting surface B_{X} as light ray 35, which in turn strikes third light-reflecting surface C_{X} and is reflected off as light ray 36, which is reflected at a direction parallel to the direction at which light ray 33 struck first light-reflecting surface A_{X}. FIGS. 12 and 13 illustrate various reflection patterns of other light rays, 37 and 38 respectively, by light reflecting layer 30. Accordingly, by manipulating the size of the various angles γ_{X}, δ_{X}, and θ_{X}, and by manipulating the orientation of the surfaces of the inverted tetrahedral-shaped cells of light-reflecting layer 30 relative to the surface of the radiator, the amount of light reflected onto the solar panels from light-reflecting layer 30 may be reduced, minimized or eliminated throughout the spacecraft's orbit for all normal spacecraft operation orientations with respect to the sun.

While FIGS. 6 and 10 illustrate two exemplary embodiments of light reflecting layer 12 of FIG. 3, it will be understood that the invention is not limited to these two embodiments. Rather, light-reflecting layer 12 may have any suitable configuration that reflects less light to the solar panels of a spacecraft than would a second surface mirror having a flat reflecting surface. Accordingly, light-reflecting layer 12 may have any suitable number of light-reflecting surfaces, each of which is oriented at any suitable angle to the others, and each of which is oriented at any suitable angle to a surface of the radiator of the spacecraft, to reduce, minimize or eliminate the amount of light reflected onto the solar panels by light-reflecting layer 12.

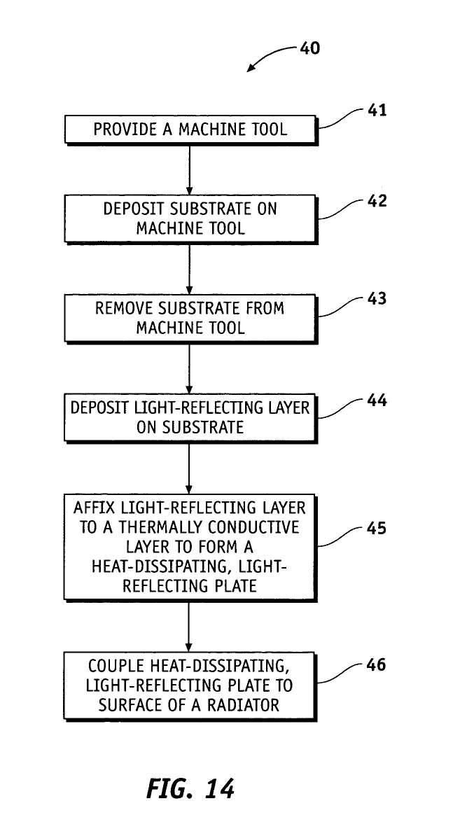

Referring again to FIG. 3 and to FIG. 14, a light-reflecting radiator plate 10 may be fabricated in accordance with the following method 40. For purposes of illustration, method 40 will be described for the fabrication of a light reflecting radiator plate 10 having a light-reflecting layer 12 configured similar to light-reflecting layer 30 as described with reference to FIG. 10. However, it will be appreciated that the method may be used to fabricate a light-reflecting layer having any suitable configuration in accordance with the present invention. The first step of method 40 comprises providing a machine tool having a surface that is the reverse image of the desired configuration for the light-reflecting layer 12, step 41. Accordingly, a machine tool, such as, for example, an aluminum plate, may be machined to form a plurality of first inclined surfaces on the aluminum plate. The aluminum plate then may be rotated 60° (sixty degrees) and may be machined to form a plurality of second inclined surfaces. The aluminum plate may be rotated again another 60° and again machined to form a plurality of third inclined surfaces. Accordingly, the orientation of the first, second and third inclined surfaces form a plurality of tetrahedrals in the surface of the aluminum plate. In one exemplary embodiment of the invention, the tetrahedrals have apexes that are distanced about 0.001 inches to about 0.0005 inches apart and have depths in the range of about 0.001 inches to about 0.0005 inches.

A polymer material, preferably a space-qualified polyimide, is then deposited overlying the aluminum plate to form a substrate 13 that has a patterned surface that is the reverse image of the aluminum plate, step 42. In other words, the patterned surface of substrate 13 has a plurality of inverted tetrahedral-shaped or corner cube-shaped cells. After the polymer material has cured or otherwise solidified, substrate 13 is removed from the aluminum plate, step 43, and a reflective material is deposited overlying the patterned surface of substrate 13 to form light-reflecting layer 12, step 44. The reflective material may be deposited using vapor deposition, sputtering or any other deposition method well-known in the art. In one exemplary embodiment of the invention, a layer of aluminum is vapor-deposited overlying the patterned surface of substrate 13. The light-reflecting layer 12 may have a thickness in the range of about 500 angstroms to about 5000 angstroms, preferably a thickness of about 2000 angstroms. After the formation of light-reflecting layer 12 on substrate 13, the light-reflecting layer 12 is affixed to a thermally conductive layer 11 to form a heat-dissipating, light-reflecting plate 10, step 45. In accordance with an exemplary embodiment of the invention, light-reflecting layer 12 is affixed to a thermally conductive layer 11 formed of high-quality fused silica having a thickness of about 0.005 to 0.006 inches. Light-reflecting layer 12 and thermally conductive layer 11 may be affixed using a silicone adhesive or using any other suitable method described above. Upon formation of heat-dissipating, light-reflecting radiator plate 10, heat-dissipating, light-reflecting radiator plate 10 may be coupled to a surface of a spacecraft radiator, such as, for example, by using a thermally conductive adhesive or using any other suitable method described above, step 46.

In an alternative embodiment of the invention, once the machine tool has been fabricated, an at least partially transparent, thermally conductive material may be deposited overlying the machine tool to form a thermally conductive layer 11 that has a patterned surface that is the reverse image of the machine tool. Thermally conductive layer 11 then is removed from the machine tool and a reflective material may be deposited overlying the patterned surface of thermally conductive layer 11 to form light-reflecting layer 12. After the formation of light-reflecting layer 12 on thermally conductive layer 11, in one exemplary embodiment of the invention, light-reflecting layer 12 may be coupled to a surface of a spacecraft radiator using any suitable method described above. For example, light-reflecting layer 12 may be affixed to a surface of a spacecraft radiator using a space-qualified adhesive. In another exemplary embodiment of the invention, a substrate layer may be formed overlying light-reflecting layer 12 and the substrate may be affixed to a surface of a spacecraft radiator using any of the methods described above, such as, for example, a space-qualified adhesive.

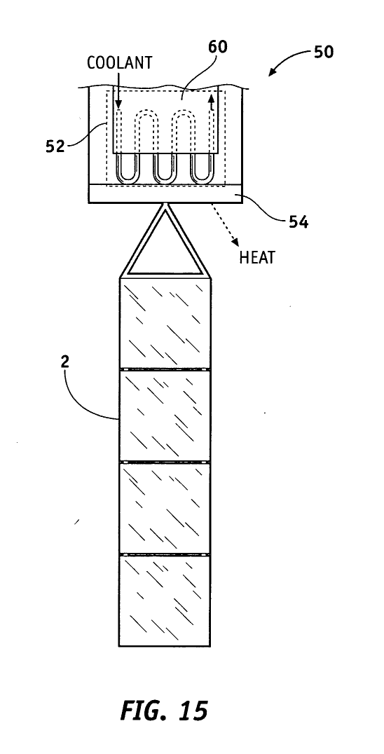

FIG. 15 is a cross-sectional view of a radiator system 50 in accordance with an exemplary embodiment of the present invention. Radiator system 50 comprises a heat-transport apparatus 52 configured to transport heat from a heat-generating portion 60 of a spacecraft to a heat-dissipating, light-reflecting plate 54. Heat-dissipating, light-reflecting plate 54 may be configured in accordance with any of the above-described embodiments of the present invention, including, for example, heat-dissipating, light-reflecting plate 10 of FIGS. 3 or 4 or heat-dissipating, light-reflecting plate 17 of FIG. 5. In one exemplary embodiment of the present invention, heat-transport apparatus 52 may comprise one or more heat pipes or fluid flow loops 56 that utilize a coolant that absorbs heat from the electrical components of the heat-generating portion 60 of the spacecraft and transfers the heat to heat-dissipating, light-reflecting plate 54 for dissipation. However, it will be understood that any suitable heat exchange mechanism configured to transport heat from portions of the spacecraft to heat-dissipating, light-reflecting plate 54 may be used. A radiator system for the spacecraft may comprise one radiator 50 or may comprise a plurality of radiators 50 configured as fins, blades, and the like.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. A heat-dissipating, light-reflecting plate for a radiator of a spacecraft, the heat-dissipating, light-reflecting plate comprising:
an at least partially transparent, thermally conductive layer;
a plurality of first light-reflecting surfaces disposed proximate to said at least partially transparent, thermally conductive layer; and
a plurality of second light-reflecting surfaces disposed proximate to said at least partially transparent, thermally conductive layer, wherein at least a first sub-set of said plurality of second light-reflecting surfaces is oriented at a first angle to at least a first sub-set of said plurality of first light-reflecting surfaces.

2. The heat-dissipating, light-reflecting plate of claim 1, wherein the heat-dissipating, light-reflecting plate lies in a plane and wherein said at least a first sub-set of said plurality of first light-reflecting surfaces is disposed at an angle of about 78.25° from an axis that is normal to said plane of the heat-dissipating, light-reflecting plate and said at least a first sub-set of said plurality of second light-reflecting surfaces is disposed at an angle of about 11.75° from said axis.

3. The heat-dissipating, light-reflecting plate of claim 1, wherein a second sub-set of said plurality of second light-reflecting surfaces is oriented at a second angle to a second sub-set of said plurality of first light-reflecting surfaces and wherein said first angle is not equal to said second angle.

4. The heat-dissipating, light-reflecting plate of claim 1, further comprising a plurality of third light-reflecting surfaces disposed proximate to said at least partially transparent, thermally conductive layer, wherein at least a first sub-set of said plurality of third light-reflecting surfaces is oriented at a second angle to at least a second sub-set of said plurality of first light-reflecting surfaces and is oriented at a third angle to at least a second sub-set of said plurality of second light-reflecting surfaces.

5. The heat-dissipating, light-reflecting plate of claim 4, wherein a second sub-set of said plurality of third light-reflecting surfaces is oriented at a fourth angle to a third sub-set of said plurality of first light-reflecting surfaces and wherein said second angle and said fourth angle are not equal.

6. The heat-dissipating, light-reflecting plate of claim 4, wherein a second sub-set of said plurality of third light-reflecting surfaces is oriented a fourth angle to a third sub-set of said plurality of second light-reflecting surfaces and wherein said third angle and said fourth angle are not equal.

7. The heat-dissipating, light-reflecting plate of claim 4, wherein said first angle, said second angle and said third angle are equal.

8. The heat-dissipating, light-reflecting plate of claim 1, said at least partially transparent, thermally conductive layer comprising a space-qualified material that is absorptive in the infrared region of the electromagnetic spectrum and that is at least partially transparent in the visible region of the electromagnetic spectrum and in the region of the electromagnetic spectrum comprising wavelengths in the range of about 250 nm to about 400 nm.

9. The heat-dissipating, light-reflecting plate of claim 8, said at least partially transparent, thermally conductive layer comprising fused silica.

10. The heat-dissipating, light-reflecting plate of claim 1, said plurality of first light-reflecting surfaces and said plurality of second light-reflecting surfaces comprising a reflective metal.

11. The heat-dissipating, light-reflecting plate of claim 10, said reflective metal comprising aluminum.

12. The heat-dissipating, light-reflecting plate of claim 1, further comprising a thermally conductive substrate that is integrally formed with said plurality of first light-reflecting surfaces and said plurality of second light-reflecting surfaces.

13. The heat-dissipating, light-reflecting plate of claim 1, further comprising a thermally conductive substrate underlying said plurality of first light-reflecting surfaces and said plurality of second light-reflecting surfaces.

14. The heat-dissipating, light-reflecting plate of claim 13, said thermally conductive substrate comprising a space-qualified polyimide.

15. The heat-dissipating, light-reflecting plate of claim 1, wherein said plurality of first light-reflecting surfaces and said plurality of second light-reflecting surfaces are oriented as a plurality of parallel channels.

16. The heat-dissipating, light-reflecting plate of claim 15, wherein each of said plurality of parallel channels has a width and a depth in the range of about 0.001 to about 0.005 inches.

17. The heat-dissipating, light-reflecting plate of claim 4, wherein said plurality of first light-reflecting surfaces, said plurality of second light-reflecting surfaces, and said plurality of third light-reflecting surfaces are oriented as a plurality of inverted tetrahedral-shaped cells.

18. The heat-dissipating, light-reflecting plate of claim 17, wherein each of said plurality of inverted tetrahedral-shaped cells has a width in the range of about 0.001 to about 0.010 inches and a depth in the range of about 0.001 to about 0.005 inches.

19. The heat-dissipating, light-reflecting plate of claim 4, wherein said plurality of first light-reflecting surfaces, said plurality of second light-reflecting surfaces, and said plurality of third light-reflecting surfaces are mutually orthogonal.

20. A radiator system of a spacecraft, the radiator system comprising:
a heat-transport apparatus; and
a heat-dissipating, light-reflecting plate disposed proximate to said heat-transport apparatus and configured to receive heat from said heat-transport apparatus, said heat-dissipating, light-reflecting plate comprising:
an at least partially transparent, thermally conductive layer;
a plurality of first light-reflecting surfaces disposed proximate to said at least partially transparent, thermally conductive layer; and
a plurality of second light-reflecting surfaces disposed proximate to said at least partially transparent, thermally conductive layer, wherein at least a first sub-set of said plurality of second light-reflecting surfaces is oriented at a first angle to at least a first sub-set of said plurality of first light-reflecting surfaces.

21. The radiator system of claim 20, said heat-transport apparatus comprising a coolant and a plurality of heat pipes configured to permit said coolant to flow from a heat-generating portion of the spacecraft to said heat-dissipating, light reflecting plate.

22. The radiator system of claim 20, wherein a second sub-set of said plurality of second light-reflecting surfaces is oriented at a second angle to a second sub-set of said plurality of first light-reflecting surfaces and wherein said first angle is not equal to said second angle.

23. The radiator system of claim 20, further comprising a plurality of third light-reflecting surfaces disposed proximate to said at least partially transparent, thermally conductive layer, wherein at least a first sub-set of said plurality of third light-reflecting surfaces is oriented at a second angle to at least a second sub-set of said plurality of first light-reflecting surfaces and is oriented at a third angle to at least a second sub-set of said plurality of second light-reflecting surfaces.

24. The radiator system of claim 23, wherein a second sub-set of said plurality of third light-reflecting surfaces is oriented a fourth angle to a third sub-set of said plurality of first light-reflecting surfaces and wherein said second angle and said fourth angle are not equal.

25. The radiator system of claim 23, wherein a second sub-set of said plurality of third light-reflecting surfaces is oriented a fourth angle to a third sub-set of said plurality of second light-reflecting surfaces and wherein said third angle and said fourth angle are not equal.

26. The radiator system of claim 23, wherein said first angle, said second angle and said third angle are equal.

27. The radiator system of claim 20, said at least partially transparent, thermally conductive layer comprising a space-qualified material that is absorptive in the infrared region of the electromagnetic spectrum and that is at least partially transparent in the visible region of the electromagnetic spectrum and in the region of the electromagnetic spectrum comprising wavelengths in the range of about 250 nm to about 400 nm.

28. The radiator system of claim 20, said at least partially transparent, thermally conductive layer comprising fused silica.

29. The radiator system of claim 20, said plurality of first light-reflecting surfaces and said plurality of second light-reflecting surfaces comprising a reflective metal.

30. The radiator system of claim 29, said reflective metal comprising aluminum.

31. The radiator system of claim 20, wherein said heat-dissipating, light-reflecting plate further comprises a substrate that is integrally formed with said plurality of first light-reflecting surfaces and said plurality of second light-reflecting surfaces.

32. The radiator system of claim 20, wherein said heat-dissipating, light-reflecting plate further comprises a substrate underlying said plurality of first light-reflecting surfaces and said plurality of second light-reflecting surfaces.

33. The radiator system of claim 32, said substrate comprising space-qualified polyimide.

34. The radiator system of claim 20, wherein said plurality of first light-reflecting surfaces and said plurality of second light-reflecting surfaces are oriented as a plurality of parallel channels.

35. The radiator system of claim 34, wherein each of said plurality of parallel channels has a width and a depth in the range of about 0.001 to about 0.005 inches.

36. The radiator system of claim 23, wherein said plurality of first light-reflecting surfaces, said plurality of second light-reflecting surfaces, and said plurality of third light-reflecting surfaces are oriented as a plurality of inverted tetrahedral-shaped cells.

37. The radiator system of claim 36, wherein each of said plurality of inverted tetrahedral-shaped cells has a width and a depth in the range of about 0.001 to about 0.005 inches.

38. The radiator system of claim 23, wherein said plurality of first light-reflecting surfaces, said plurality of second light-reflecting surfaces, and said plurality of third light-reflecting surfaces are mutually orthogonal.

39. A spacecraft radiator system comprising:
a heat-generating portion of a spacecraft;
a heat-transport apparatus coupled to said heat-generating portion of said spacecraft and configured to remove heat from said heat-generating portion of the spacecraft; and
a heat-dissipating, light-reflecting plate disposed proximate to said heat-transport apparatus, said heat-dissipating, light-reflecting plate comprising:
an at least partially transparent, thermally conductive layer;
a plurality of first light-reflecting surfaces disposed proximate to said at least partially transparent, thermally conductive layer; and
a plurality of second light-reflecting surfaces disposed proximate to said at least partially transparent, thermally conductive layer, wherein at least a first sub-set of said plurality of second light-reflecting surfaces is oriented at a first angle to at least a first sub-set of said plurality of first light-reflecting surfaces.

40. The spacecraft radiator system of claim 39, said heat-transport apparatus comprising a coolant formulated to transport heat and a plurality of heat pipes configured to permit said coolant to flow from proximate to said heat-generating portion of said spacecraft to proximate to said heat-radiating, light reflecting plate.

41. The spacecraft radiator system of claim 39, wherein a second sub-set of said plurality of second light-reflecting surfaces is oriented at a second angle to at least a second sub-set of said plurality of first light-reflecting surfaces and wherein said first angle is not equal to said second angle.

42. The spacecraft radiator system of claim 39, further comprising a plurality of third light-reflecting surfaces disposed proximate to said at least partially transparent, thermally conductive layer, wherein at least a first sub-set of said plurality of third light-reflecting surfaces is oriented at a second angle to at least a second sub-set of said plurality of first light-reflecting surfaces and is oriented at a third angle to at least a second sub-set of said plurality of second light-reflecting surfaces.

43. The spacecraft radiator system of claim 42, wherein a second sub-set of said plurality of third light-reflecting surfaces is oriented at a fourth angle to a third sub-set of said plurality of first light-reflecting surfaces and wherein said second angle and said fourth angle are not equal.

44. The spacecraft radiator system of claim 42, wherein a second sub-set of said plurality of third light-reflecting surfaces is oriented at a fourth angle to a third sub-set of said plurality of second light-reflecting surfaces and wherein said third angle and said fourth angle are not equal.

45. The spacecraft radiator system of claim 42, wherein said first angle, said second angle and said third angle are equal.

46. The spacecraft radiator system of claim 39, wherein said at least partially transparent, thermally conductive layer comprises a space-qualified material that is absorptive in the infrared region of the electromagnetic spectrum and that is at least partially transparent in the visible region of the electromagnetic spectrum and in the region of the electromagnetic spectrum comprising wavelengths in the range of about 250 nm to about 400 nm.

47. The spacecraft radiator system of claim 39, said at least partially transparent, thermally conductive layer comprising fused silica.

48. The spacecraft radiator system of claim 39, said plurality of first light-reflecting surfaces and said plurality of second light-reflecting surfaces comprising a reflective metal.

49. The spacecraft radiator system of claim 48, said reflective metal comprising aluminum.

50. The spacecraft radiator system of claim 39, further comprising a substrate that is integrally formed with said plurality of first light-reflecting surfaces and said plurality of second light-reflecting surfaces.

51. The spacecraft radiator system of claim 39, further comprising a substrate underlying said plurality of first light-reflecting surfaces and said plurality of second light-reflecting surfaces.

52. The spacecraft radiator system of claim 51, said substrate comprising space-qualified polyimide.

53. A method of fabricating a heat dissipating light-reflecting plate for a radiator of a spacecraft, the method comprising:
providing a machine tool having a patterned surface with a plurality of first inclined surfaces thereon and a plurality of second inclined surfaces thereon, wherein at least a first sub-set of said plurality of second inclined surfaces is oriented at a first angle to at least a first sub-set of said plurality of first inclined surfaces;
depositing a first space-qualified, thermally conductive material overlying said surface of said machine tool so that said first space-qualified, thermally conductive material has a patterned surface that is a reverse image of said patterned surface of said machine tool;
removing said first space-qualified, thermally conductive material from said machine tool;
forming a light-reflecting layer overlying said patterned surface of said first space-qualified, thermally conductive material; and
coupling said light-reflecting layer to a radiator of a spacecraft.

54. The method of fabricating a heat dissipating, light-reflecting plate for a radiator of a spacecraft of claim 53, wherein the step of depositing a first space-qualified, thermally conductive material comprises depositing a space-qualified polymer and the method further comprises forming overlying said light-reflecting layer a second space-qualified, thermally conductive layer.

55. The method of fabricating a heat dissipating, light-reflecting plate for a radiator of a spacecraft of claim 54, wherein the step of depositing a first space-qualified, thermally conductive material comprises depositing space-qualified polyimide.

56. The method of fabricating a heat dissipating, light-reflecting plate for a radiator of a spacecraft of claim 54, wherein the step of forming overlying said light-reflecting layer a second space-qualified, thermally conductive layer comprises forming overlying said light-reflecting layer a layer of a space-qualified material that is absorptive in the infrared region of the electromagnetic spectrum and that is at least partially transparent in the visible region of the electromagnetic spectrum and in the region of the electromagnetic spectrum comprising wavelengths in the range of about 250 nm to about 400 nm.

57. The method of fabricating a heat dissipating, light-reflecting plate for a radiator of a spacecraft of claim 56, wherein the step of forming overlying said light-reflecting layer a layer of a second space-qualified, thermally conductive layer comprises forming overlying said light-reflecting layer a layer of fused silica.

58. The method of fabricating a heat dissipating, light-reflecting plate for a radiator of a spacecraft of claim 53, wherein the step of depositing a first space-qualified, thermally conductive material comprises depositing a space-qualified material that is absorptive in the infrared region of the electromagnetic spectrum and that is at least partially transparent in the visible region of the electromagnetic spectrum and in the region of the electromagnetic spectrum comprising wavelengths in the range of about 250 nm to about 400 nm.

59. The method of fabricating a heat dissipating, light-reflecting plate for a radiator of a spacecraft of claim 58, wherein the step of depositing a first space-qualified, thermally conductive material comprises depositing fused silica.

60. The method of fabricating a heat dissipating, light-reflecting plate for a radiator of a spacecraft of claim 54, wherein the step of coupling said light-reflecting layer to a radiator of a spacecraft comprises affixing said space-qualified polymer to a surface of said radiator of said spacecraft.

61. The method of fabricating a heat dissipating, light-reflecting plate for a radiator of a spacecraft of claim 60, wherein the step of affixing said space-qualified polymer to a surface of said radiator of said spacecraft comprises adhering said space-qualified polymer to said surface of said radiator of said spacecraft utilizing a space-qualified, thermally conductive adhesive.

62. The method of fabricating a heat dissipating, light-reflecting plate for a radiator of a spacecraft of claim 58, wherein the step of coupling said light-reflecting layer to a radiator of a spacecraft comprises affixing said light-reflecting layer to said radiator of said spacecraft.

63. The method of fabricating a heat dissipating, light-reflecting plate for a radiator of a spacecraft of claim 62, wherein the step of coupling said light-reflecting layer to a radiator of a spacecraft comprises adhering said light-reflecting layer to said radiator of said spacecraft utilizing a space-qualified, thermally conductive adhesive.

64. The method of fabricating a light-reflecting plate for a radiator of a spacecraft of claim 53, the step of providing a machine tool comprising providing said machine tool having said patterned surface with said plurality of second inclined surfaces oriented at a second angle to at least a second sub-set of said plurality of first inclined surfaces.

65. The method of fabricating a light-reflecting plate for a radiator of a spacecraft of claim 53, the step of providing a machine tool comprising providing said machine tool having said patterned surface with a plurality of third inclined surfaces thereon, wherein at least a first sub-set of said plurality of third inclined surfaces is oriented at a second angle to at least a second sub-set of said plurality of first inclined surfaces and is oriented at a third angle to at least a second sub-set of said plurality of second inclined surfaces.

66. The method of fabricating a light-reflecting plate for a radiator of a spacecraft of claim 53, the step of forming a light-reflecting layer overlying said surface of said first space-qualified, thermally conductive material comprising depositing a layer of reflective metal overlying said surface of said first space-qualified, thermally conductive material.
